(19) United States
(12) Patent Application Publication
(10) Pub. No.: US 2024/0414816 A1
(43) Pub. Date: Dec. 12, 2024

(54) VEHICLE PART INTENDED TO BE PLACED FACING AN EMISSION CONE OF A RADAR SENSOR OF THE VEHICLE AND COMPRISING A DEICING SYSTEM

(71) Applicant: VALEO VISION, Bobigny (FR)

(72) Inventors: Pierre RENAUD, Bobigny (FR); Pierre ALBOU, Bobigny (FR); Alexandre FRANC, Bobigny (FR); David BODUDIKIAN, Bobigny (FR)

(73) Assignee: VALEO VISION, Bobigny (FR)

(21) Appl. No.: 18/688,906

(22) PCT Filed: Aug. 4, 2022
(86) PCT No.: PCT/EP2022/072009

§ 371 Date: Mar. 4, 2024

(30) Foreign Application Priority Data
Sep. 3, 2021 (FR) 2109260

(51) Int. Cl. H05B 3/84; H01Q 1/02; H01Q 1/32; H01Q 15/24

(52) U.S. Cl. CPC H05B 3/84; H01Q 1/02; H01Q 1/32; H01Q 15/24

(57) ABSTRACT

The invention relates to a vehicle part intended to be placed facing an emission cone of a radar sensor, the radar sensor being configured to emit an electromagnetic wave the electric field of which includes a component oscillating in a direction of interest. The vehicle part includes a system for deicing the part. According to the invention, the deicing system includes a set of slender heatable elements, at least one sub-set of the set of slender heatable elements being located in the emission cone of the radar sensor and being configured so that each slender heatable element of the sub-set is placed on the part so as to extend in a direction substantially perpendicular to the main polarization direction of the radar sensor when the part is placed facing the radar sensor.

### TECHNICAL FIELD

The present invention belongs to the field of integration of radar sensors in motor vehicles, and in particular to the field of deicing systems for motor vehicles making it possible to maintain reliability of detection by such radar sensors. The invention relates in particular to a vehicle part intended to be placed facing an emission cone of a radar sensor of the vehicle, and comprising such a deicing system.

### BACKGROUND OF THE INVENTION

Autonomous or partially autonomous vehicles need a large number of sensors that are responsible for receiving redundant data from the vehicle's surroundings, to avoid collisions and ensure that the vehicle arrives at its destination safely. These sensors, many of which are radar sensors, are placed in predetermined locations on the vehicle such that the data cover as much information as possible. The lighting devices of the vehicle (headlamp, tail lamp, etc.) are generally advantageous locations for such radar sensors, although other locations on the vehicle are also possible.

The electromagnetic wave emitted by such radar sensors is generally linearly polarized. By convention, the polarization of the electromagnetic wave describes the vibration of the electric field. When the wave is linearly polarized, this electric field oscillates in only one direction, and this is the main polarization direction, conventionally a horizontal or vertical polarization direction.

One problem linked to the integration of such a radar sensor in a motor vehicle lies in the need for the sensor to be able to detect external objects whatever the weather conditions in which the vehicle is operating. However, for temperatures below the threshold of 0° C., a layer of frost is likely to form on the emission/reception location(s) of the radar sensor on the vehicle. Such a layer of frost then reflects and absorbs a very large part of the radar waves emitted, owing to the very high refractive index of water. The range of the radar may then be significantly reduced, and the detection functionality of the radar sensor may no longer be operational within the vehicle.

In order to address this problem it is known practice to use, at the reception location of the radar sensor on the vehicle, a deicing system making it possible to maintain the detection functionalities of the sensor.

Published patent WO 2020/239380 A1 discloses for example such a deicing system for a vehicle component prone to the problem of icing (such as a radar sensor for example). The deicing system is installed outside the emission cone of the radar sensor, on the edges of the sensor reception housing. The heat for deicing is transmitted into the system through the use of an electrically conductive elastomeric material. Electricity applied to the elastomeric material produces the heat necessary for deicing.

However, such a deicing system cannot be placed inside the emission cone of the radar sensor without affecting the electromagnetic wave emitted by the sensor. As a result, the space available for the deicing system on the radar sensor reception housing on the vehicle is relatively restricted, because it is limited to the edges of the housing. This imposes a size constraint on the deicing system, which substantially limits the deicing rate. Moreover, this deicing rate is dependent on the electrical conductivity of the elastomeric material used.

### SUMMARY OF THE INVENTION

The present invention improves the situation.

One aim of the invention is to propose a vehicle part intended to be placed facing an emission cone of a radar sensor of the vehicle, and comprising a deicing system which can be placed inside the emission cone of the radar sensor without affecting the electromagnetic wave emitted by the sensor and therefore without impairing the efficiency of the latter, while having a faster deicing rate.

To this end, a first aspect of the invention relates to a vehicle part intended to be placed facing an emission cone of a radar sensor of the vehicle, the radar sensor being configured to emit an electromagnetic wave in the emission cone, the electric field of the electromagnetic wave emitted by the radar sensor comprising a component oscillating in a direction of interest, the electromagnetic wave propagating in a main propagation direction, said part having on one of its faces a system for deicing the part. The emission cone of the radar sensor corresponds to the angular zone in which the sensor emits. This angular zone has a main direction which corresponds to the main propagation direction of the wave for which the amplitude of the wave is maximum. The direction of interest of the electric field of the electromagnetic wave corresponds to a preferred direction, perpendicular to the main propagation direction of the wave. The electric field of the electromagnetic wave emitted by the radar sensor may be non-polarized, or linearly polarized (typically in a vertical or horizontal direction, or in any rectilinear direction other than the vertical or horizontal direction). When the radar sensor is linearly polarized in a main polarization direction (for example horizontal or vertical), the direction of interest corresponds to this main polarization direction. In this case, the electric field of the wave only includes its component of interest.

According to the invention, the deicing system comprises a set of elongate heating elements, at least one subset of said set of elongate heating elements being located in the emission cone of the radar sensor when the part is placed facing the radar sensor and being configured such that each elongate heating element of said subset is arranged on the part in such a way as to extend in a direction substantially perpendicular to the direction of interest of the electric field of the electromagnetic wave emitted by the radar sensor when the part is placed facing the radar sensor.

Thus, owing to the orientation of the elongate heating elements located in the emission cone of the radar sensor, which are arranged on the part in such a way as to extend in a direction substantially perpendicular to the direction of interest of the electric field of the electromagnetic wave emitted by the radar sensor, the deicing system allows the component of interest of the electromagnetic wave to pass through. This component of interest is virtually not reflected by the elongate heating elements and is almost entirely transmitted to the other side of the deicing system. The system for deicing the part according to the invention may thus be placed inside the emission cone of the radar sensor without affecting the electromagnetic wave emitted by the sensor and therefore without impairing the efficiency of the latter. Furthermore, by varying the number and density of the elongate heating elements, the deicing rate is advantageously increased compared to the systems of the prior art.

According to a preferred embodiment of the invention, the elongate heating elements extend in the same plane, said plane extending perpendicular to the main propagation direction of the electromagnetic wave emitted by the radar sensor.

According to one embodiment of the invention, the elongate heating elements extend parallel to one another in said plane, the set of elongate heating elements forming a grid wave polarizer.

According to a first embodiment of the invention, the elongate heating elements are arranged such that the distance separating two adjacent elongate heating elements is constant.

According to one embodiment of the invention, the distance separating two adjacent elongate heating elements is less than the wavelength of the electromagnetic wave emitted by the radar sensor.

According to one embodiment of the invention, the distance separating two adjacent elongate heating elements is less than 5 mm, preferably between 1 mm and 5 mm, more preferably between 2 mm and 4 mm.

According to one embodiment of the invention, the ratio between the width of each elongate heating element and the wavelength of the electromagnetic wave emitted by the radar sensor is less than 1/10.

According to one embodiment of the invention, the width of each elongate heating element is less than 0.5 mm, preferably substantially equal to 0.4 mm.

According to a second embodiment of the invention, a first subset of elongate heating elements is located in the emission cone of the radar sensor when the part is placed facing the radar sensor, and a second subset of elongate heating elements is located outside the emission cone of the radar sensor when the part is placed facing the radar sensor, the elongate heating elements of the first and second subsets being arranged such that, considering a direction of travel from the second subset to the first subset perpendicular to the main propagation direction of the electromagnetic wave emitted by the radar sensor, and from the outside of the emission cone of the radar sensor to the center of said emission cone, the distance separating two adjacent elongate heating elements is non-constant and follows an increasing distance profile function. This second embodiment of the invention makes it possible to further increase the deicing rate compared to the first embodiment of the invention in which the elongate heating elements extend parallel to one another forming a grid wave polarizer, with a constant distance between two adjacent elongate heating elements. To be specific, in this second embodiment, the density of the elongate heating elements of the second subset is maximized outside the emission cone of the radar sensor, in order to maximize the electrical conductivity and therefore the deicing rate. Conversely, inside the emission cone of the radar sensor, the distance between two adjacent elongate heating elements of the first subset is greater than the distance between two adjacent elongate heating elements of the second subset. This makes it possible to minimize the attenuation of the signal coming from the radar sensor, whatever the component of the electromagnetic wave in question. According to a first variant of this second embodiment, inside the emission cone of the radar sensor, the elongate heating elements of the first subset are arranged such that the distance between two adjacent elongate heating elements increases the closer they are transversely to the center of the cone. According to another variant of this second embodiment, the distance separating two adjacent elongate heating elements of the first subset is constant.

According to one embodiment of the invention, said increasing distance profile function is a linear function, or a piecewise linear function, for example a step function.

According to one embodiment of the invention, the minimum distance separating two adjacent elongate heating elements of the first subset of elongate heating elements is greater than 2 mm, preferably greater than 3 mm.

According to one embodiment of the invention, the width of each elongate heating element of the first subset of elongate heating elements is less than 0.5 mm.

According to one embodiment of the invention, the elongate heating elements are heating metal strips or wires. The heating metal strips or wires are for example powered by a common electrical power supply unit configured to circulate an electric current within each of the metal strips or wires. The heat necessary for deicing is then produced by Joule effect in the metal strips or wires. The electrical power supply unit is for example connected to the heating metal strips or wires via one or more electrical connection elements (such as for example electrical current distribution bars, electrical cables and/or an electrical power supply ribbon cable). These electrical connection elements, which are generally made of a non-transparent electrically conductive material, are arranged in the part outside the emission cone of the radar sensor.

According to one embodiment of the invention, each heating metal strip or wire is coated with a layer of a dielectric material or is arranged in a dielectric protection and insulation element.

According to one embodiment of the invention, the dielectric material has a refractive index and a thickness which is between 0.8 times and 1.2 times an ideal thickness, the ideal thickness being equal to a natural number multiplied by the wavelength of the electromagnetic wave emitted by the radar sensor and divided by twice the refractive index of the dielectric material, for a zero angle of incidence of the electromagnetic wave (normal electromagnetic wave). This ideal thickness is such that the electromagnetic waves reflected by the heating metal strips or wires undergo destructive interference, thus minimizing or even eliminating any attenuation of the signal from the radar sensor. The transmission of the signal through the metal strips or wires is thus maximized, whatever the component of the electromagnetic wave in question. In certain particular cases, the thickness of the dielectric material is between 0.8 times and 1.2 times the wavelength divided by twice the refractive index. This thickness, which corresponds to the minimum possible for this embodiment of the invention, makes it possible to avoid other interference.

According to one embodiment of the invention, the vehicle part is a style part intended to conceal the radar sensor.

For example, the style part may be a logo.

According to one embodiment of the invention, the vehicle part is an outer lens that closes off a lighting and/or signaling element in which the radar sensor is integrated.

Further subject matter of the invention relates to an assembly comprising a vehicle radar sensor and a vehicle part according to the invention, wherein the radar sensor is configured to emit an electromagnetic wave in an emission cone, the electric field of the electromagnetic wave emitted by the radar sensor comprising a component oscillating in a direction of interest, the electromagnetic wave propagating in a main propagation direction, the vehicle part being placed facing the emission cone of the radar sensor.

According to one embodiment of the invention, the radar sensor is a millimeter radar sensor polarized in a horizontal or vertical polarization direction. The oscillation of the electric field of the electromagnetic wave then extends in the horizontal or vertical direction. The wavelength of the radar sensor is typically between 3.70 mm and 3.94 mm. This type of radar sensor is typically suited to autonomous driving applications, and such a wavelength is advantageously suited to detecting objects without excessive power consumption or delayed response.

According to one embodiment of the invention, the radar sensor has an operating frequency of between 76 GHz and 81 GHz.

According to one embodiment of the invention, the assembly is a lighting and/or signaling element of a vehicle, in particular a vehicle headlamp. For example, the vehicle part may be an outer lens that closes off said lighting and/or signaling element, said outer lens constituting a face of said element. Such a lighting and/or signaling element may then house the radar sensor.

Herein, “vehicle” means any type of vehicle such as a motor vehicle, a moped, a motorbike, a warehouse robot, or any other machine able to carry at least one passenger or intended to transport people or objects.

“Electrical cable” means one or more elongate electrically conductive element(s) surrounded by at least one electrically insulating layer, the electrically insulating layer possibly being directly in physical contact with the elongate electrically conductive element(s).

“Electrical power supply ribbon cable” also means an electrical power supply element the thickness of which is small in relation to its length and its width. It may be curved and have a given contour. Thus, the ribbon cable has two extensive faces separated by a periphery, this periphery defining a thickness of the ribbon cable, which may be variable, for example decreasing from one end to the other.

### BRIEF DESCRIPTION OF THE DRAWINGS

Other features and advantages of the invention will become apparent on examining the following detailed description and the appended drawings, in which:

FIG. 1 is a schematic perspective view of an assembly comprising a radar sensor and a vehicle part according to a first embodiment of the invention;

FIG. 2 is a schematic face-on view of the vehicle part of FIG. 1;

FIG. 3 is a schematic side view of the vehicle part of FIG. 1;

FIG. 4 is a schematic face-on view of a vehicle part according to a second embodiment of the invention; and

FIG. 5 schematically depicts an electrical circuit equivalent to the configuration of FIG. 3.

In this document, unless specified otherwise, the terms “upstream” and “downstream” refer to the direction of propagation of the electromagnetic beam in the object in question, and also to the direction of emission of the electromagnetic wave outside said object.

Additionally, everything called “rear” is located on the upstream side, while everything called “front” is located on the downstream side.

The terms “horizontal”, “vertical”, “transverse”, “lower”, “upper”, “high”, “low” and “side” are defined with respect to the orientation of the part 2 according to the invention, intended to be fitted in the vehicle. In particular, in this application, the term “vertical” denotes an orientation perpendicular to the horizon, while the term “horizontal” denotes an orientation parallel to the horizon.

An orthogonal reference frame associated with the vehicle part 2 is shown in FIGS. 1 to 4. This reference frame is composed of three axes X, Y and Z, referred to herein as the longitudinal axis X, the transverse axis Y and the vertical axis Z, respectively.

### DETAILED DESCRIPTION OF THE INVENTION

FIG. 1 is a schematic perspective view showing an assembly 1 comprising the vehicle part 2 according to the invention, and its operating principle. The assembly 1 further comprises a radar sensor 4. Only a portion of the part 2 is shown in the figures for the sake of clarity. Without implying any limitation in the context of the present invention, the assembly 1 is for example a lighting and/or signaling element of a vehicle, in particular a vehicle headlamp. In this case, the part 2 is typically an outer lens that closes off the lighting and/or signaling element 1. The outer lens 2 then constitutes a face of this element 1. Alternatively, the part 2 may be a style part intended to conceal the radar sensor 4, such as a logo. In this case, the assembly 1 may be a vehicle lighting and/or signaling element, or any other element of the vehicle.

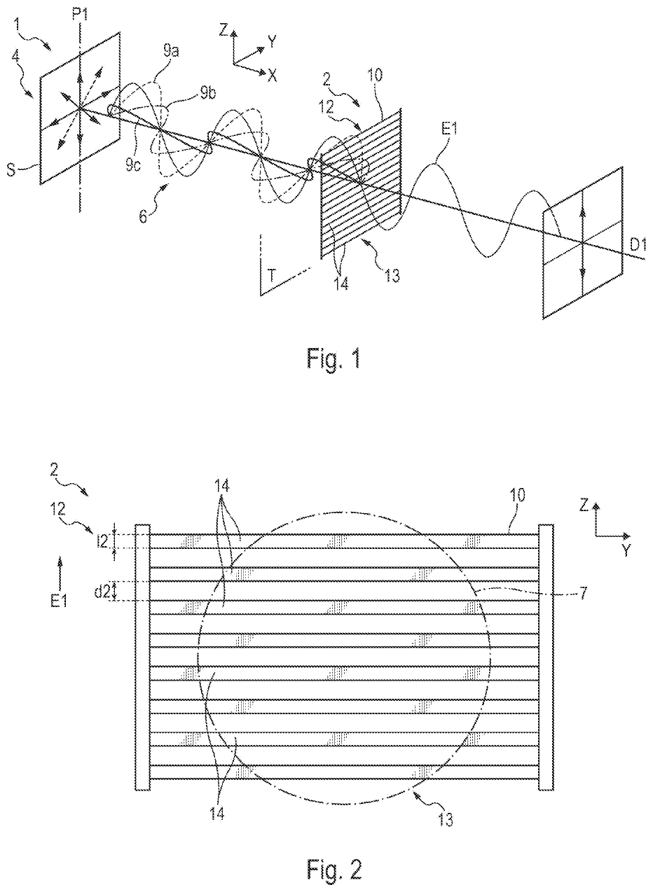

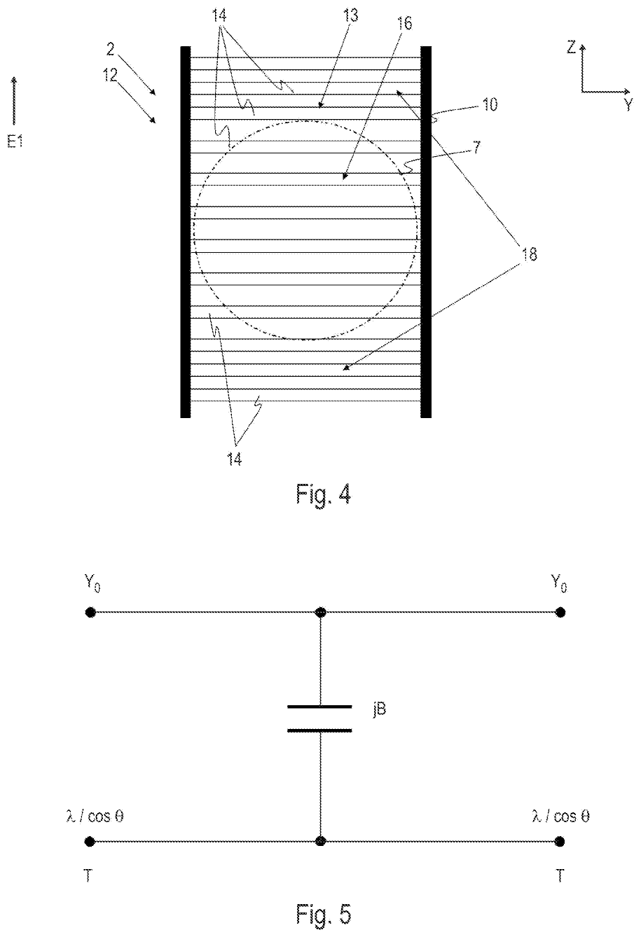

The radar sensor 4 is configured to emit an electromagnetic wave 6 in an emission cone 7 (such an emission cone 7 is not shown in FIG. 1 but is visible in FIGS. 2 and 4). The electric field of the electromagnetic wave 6 emitted by the radar sensor 4 comprises a component E1 oscillating in a direction of interest P1. More specifically, this means that this component E1 of the electric field of the electromagnetic wave 6 extends, in projection in the plane S defined by the emission surface of the radar sensor 4, in the direction of interest P1. The direction of interest P1 of the electric field of the electromagnetic wave 6 corresponds to a preferred direction, perpendicular to the main propagation direction D1 of the wave 6, in which the component of interest E1 of the electric field of the wave 6 oscillates. When the radar sensor 4 is linearly polarized in a main polarization direction (for example horizontal or vertical), the direction of interest P1 corresponds to this main polarization direction. In the exemplary embodiment illustrated in FIG. 1, the direction of interest of the wave 6 is the vertical direction, corresponding to the vertical axis Z. According to this exemplary embodiment, the electric field of the electromagnetic wave 6 emitted by the radar sensor 4 is non-polarized. In a variant that has not been shown, the electric field of the electromagnetic wave emitted by the radar sensor may be polarized vertically or horizontally, or in any rectilinear direction other than the vertical or horizontal direction.

The electromagnetic wave 6 propagates in a main propagation direction D1. The emission cone 7 of the radar sensor 4 corresponds to the angular zone in which the sensor 4 emits. This angular zone has a main direction which corresponds to the main propagation direction D1 of the wave 6 for which the amplitude of the wave is maximum. In this case, the main propagation direction D1 corresponds to the optical axis of the radar sensor 4. In the embodiment illustrated, the main propagation direction D1 is the longitudinal direction, corresponding to the longitudinal axis X in the figures.

The radar sensor 4 is typically a frequency-modulated continuous-wave millimeter radar sensor, the operating frequency of which is typically between 76 GHz and 81 GHz. The radar sensor 4 is for example a long-range radar sensor (therefore with a low field of vision) or a medium-range radar sensor (therefore with a medium field of vision). The wavelength of the radar sensor 4 is typically between 3.70 mm and 3.94 mm. This type of radar sensor is typically suited to autonomous driving applications, and such a wavelength is advantageously suited to detecting objects without excessive power consumption or delayed response.

As shown in FIGS. 1, 2 and 4, the part 2 is placed facing the emission cone 7 of the radar sensor 4, at the front of the latter. On one of its faces 10, the part 2 has a system 12 for deicing the part 2.

The deicing system 12 comprises a set 13 of elongate heating elements 14. The deicing system 12 further comprises an electrical power supply unit (not shown), connected to the elongate heating elements 14 via one or more electrical connection elements (such as for example electrical current distribution bars, electrical cables and/or an electrical power supply ribbon cable). These electrical connection elements, which are generally made of a non-transparent electrically conductive material, are arranged in the part 2 outside the emission cone 7 of the radar sensor 4. The electrical power supply unit is configured to circulate an electric current within each of the elongate heating elements 14. Each elongate heating element 14 is typically a heating metal strip or wire. The heat necessary for deicing is then produced by Joule effect in the heating metal strips or wires 14.

Preferably, each heating metal strip or wire 14 is coated with a layer of a dielectric material or is arranged in a dielectric protection and insulation element (such a dielectric material or element not being not shown in the figures for the sake of clarity). The dielectric material has a refractive index and a thickness. The thickness of the dielectric material is advantageously between 0.8 times and 1.2 times an ideal thickness, the ideal thickness being equal to a natural number multiplied by the wavelength of the electromagnetic wave 6 emitted by the radar sensor 4 and divided by twice the refractive index of the dielectric material, for a zero angle of incidence of the electromagnetic wave 6 (normal electromagnetic wave). According to a particular exemplary embodiment, the thickness of the dielectric material is between 0.8 times and 1.2 times the wavelength divided by twice the refractive index. This thickness, which corresponds to the minimum possible for this particular feature of the invention, makes it possible to avoid other interference.

All or part of the elongate heating elements 14 is located in the emission cone 7 of the radar sensor 4, as will be described in more detail below. Each elongate heating element 14 located in the emission cone 7 of the radar sensor 4 is arranged on the part 2 in such a way as to extend in a direction substantially perpendicular to the direction of interest P1 of the electric field of the electromagnetic wave 6 emitted by the radar sensor 4. In the embodiment illustrated, this direction of extension of the elongate heating elements 14 is the transverse direction, corresponding to the longitudinal axis Y in the figures. In this way, the component of interest E1 of the electromagnetic wave 6, which extends perpendicular to the direction of extension of the elongate heating elements 14 is virtually not reflected by these elements 14 and is almost entirely transmitted to the other side of the deicing system 12. In addition to its component of interest E1, the electric field of the electromagnetic wave 6 emitted by the radar sensor 4 in FIG. 1 comprises other components 9a, 9b, 9c which each extend respectively, in projection in the plane S defined by the emission surface of the radar sensor 4, in a respective direction other than the direction of interest P1. As shown in FIG. 1, these other components 9a, 9b, 9c of the electromagnetic wave 6 are reflected by the elongate heating elements 14 and are not transmitted to the other side of the deicing system 12. In a variant that has not been shown, when the radar sensor is linearly polarized, the electric field of the electromagnetic wave 6 emitted by the radar sensor 4 is composed of the component E1.

As shown in FIGS. 1 to 4, the elongate heating elements 14 extend in the same plane T. This plane extends perpendicular to the main propagation direction D1 of the electromagnetic wave 6 emitted by the radar sensor 4. In other words, the plane T in which the elongate heating elements 14 are arranged extends substantially parallel to the plane S defined by the emission surface of the radar sensor 4, at the front of this plane S. In the particular exemplary embodiment shown in FIGS. 1 to 4, the elongate heating elements 14 extend parallel to one another in the plane T. The set 13 of elongate heating elements 14 then forms a grid wave polarizer.

According to a first embodiment of the invention, shown in FIGS. 1 to 3, the set 13 of elongate heating elements 14 is located in the emission cone 7 of the radar sensor 4. The elongate heating elements 14 are arranged in such a way that the distance d2 separating two adjacent elongate heating elements 14 is constant (such a distance d2 being visible in FIG. 2 and being in this case measured in the vertical direction of the axis Z).

Preferably, the distance d2 separating two adjacent elongate heating elements 14 is less than the wavelength of the electromagnetic wave 6 emitted by the radar sensor 4. The distance d2 separating two adjacent elongate heating elements 14 is typically less than 4 mm, preferably between 2 mm and 4 mm.

More preferably, the ratio between the width 12 of each elongate heating element 14 and the wavelength of the electromagnetic wave 6 emitted by the radar sensor 4 is less than 1/10, preferably substantially equal to 1/10 (the width being in this case measured in the vertical direction of the axis Z). The width 12 of each elongate heating element 14 (visible in FIG. 2) is typically less than 0.5 mm, preferably substantially equal to 0.4 mm. Note that in FIG. 2, the distance d2 and the width 12 are not shown to scale.

According to a second embodiment of the invention, shown in FIG. 4, a first subset 16 of elongate heating elements 14 is located in the emission cone 7 of the radar sensor 4, and a second subset 18 of elongate heating elements 14 is located outside the emission cone 7 of the radar sensor 4. The elongate heating elements 14 of the second subset 18 then extend to the periphery of the emission cone 7 of the radar sensor 4. The elongate heating elements 14 of the first and second subsets 16, 18 are arranged such that, considering a direction of travel from the second subset 18 to the first subset 16 perpendicular to the main propagation direction D1 of the electromagnetic wave 6 emitted by the radar sensor 4 (therefore within the plane YZ), and from the outside of the emission cone 7 of the radar sensor 4 to the center of the emission cone 7, the distance separating two adjacent elongate heating elements 14 is non-constant and follows an increasing distance profile function. This increasing distance profile function is for example a linear function, or a piecewise linear function, for example a step function. According to a first variant of this second embodiment of the invention, inside the emission cone 7 of the radar sensor 4, the elongate heating elements 14 of the first subset 16 are arranged such that the distance between two adjacent elongate heating elements 14 increases the closer they are transversely to the center of the cone. According to another variant of this second embodiment, which is illustrated in FIG. 4, the distance separating two adjacent elongate heating elements 14 of the first subset 16 is constant inside the emission cone 7 of the radar sensor 4.

Preferably, the minimum distance separating two adjacent elongate heating elements 14 of the first subset 16 is greater than 2 mm, preferably greater than 3 mm (the distance being in this case measured in the vertical direction of the axis Z).

More preferably, the maximum distance separating two adjacent elongate heating elements 14 of the first subset 16 is less than the wavelength of the electromagnetic wave 6 emitted by the radar sensor 4.

More preferably, the width of each elongate heating element 14 of the first subset 16 is less than 0.5 mm (the width being in this case measured in the vertical direction of the axis Z). This width may be variable for each of the adjacent elongate heating elements of the first subset 16. Note that in FIG. 4, the distance separating two adjacent elongate heating elements 14 and the width of each elongate heating element 14 are not shown to scale.

In the two embodiments of the part 2 described above, the distance between two adjacent elongate heating elements and the width of each elongate heating element are calculated in such a way as to minimize the reflection of the wave 6 on the elongate elements, and therefore to maximize the transmission of this wave 6 to the other side of the elements. The calculation of these two parameters depends on the type of polarization and the wavelength of the radar sensor 4, and the angle of incidence of the wave 6, as will be explained in detail later.

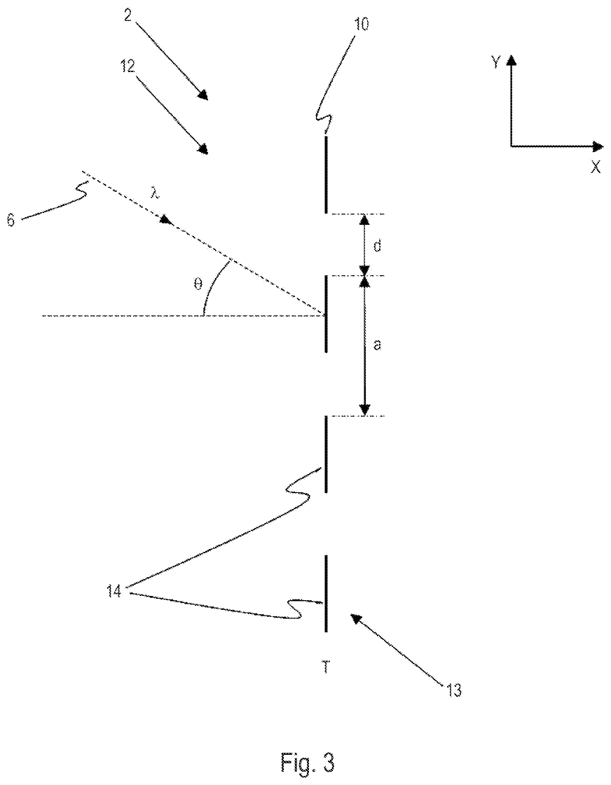

More specifically, the configuration of the part 2 shown in FIG. 3 is depicted schematically in FIG. 5 by an equivalent electrical circuit. In this equivalent electrical circuit, in which the radar sensor 4 is vertically polarized in the direction P1 which is perpendicular to the direction of extension of the elongate heating elements 14, the parameters Y0 and B are given by the following equation (1):

$$[ Math ]$$

$$\frac{B}{{Y}_{0}} = \frac{4 a cos}{λ} [ ln \frac{2 a}{π d} + \frac{1}{2} ( 3 - 2 {cos}^{2} θ {( \frac{a}{λ} )}^{2} ] ; \qquad ( 1 )$$

where

$$\frac{d}{a} ≪ 1 ; \frac{a}{λ} << 1 ;$$

d is the distance between two adjacent elongate heating elements 14;
a is the sum of the width of an elongate heating element 14 and the distance d;
Δ is the wavelength of the radar sensor 4;
θ is the angle of incidence of the electromagnetic wave 6 emitted by the radar sensor 4.

When the angle of incidence θ of the electromagnetic wave 6 is 0 degrees, the equation (1) becomes:

$$[ Math ]$$

$$\frac{B}{{Y}_{0}} = \frac{4 a}{λ} [ ln \frac{2 a}{π d} + \frac{1}{2} ( 3 - 2 {( \frac{a}{λ} )}^{2} ] ; \qquad ( 1 )$$

Based on the electrical diagram in FIG. 5, the coefficient of reflection Ry of the wave 6, which is a complex number, is then given by the following equation (2):

$$[ Math ]$$

$${R}_{v} = \frac{- jB / {Y}_{0}}{2 + jB / {Y}_{0}} ; \qquad ( 2 )$$

The distance d between two adjacent elongate heating elements 14 and the width a-d of each elongate heating element 14 are then calculated in such a way as to minimize the modulus of this coefficient of reflection Ry.

The present invention is not limited to the embodiments described above by way of examples; it encompasses other variants, in particular any variant in which at least one subset of the set of elongate heating elements 14 is located in the emission cone 7 of the radar sensor 4 and is configured such that each elongate heating element 14 of the subset is arranged on the part 2 in such a way as to extend in a direction substantially perpendicular to the direction of interest P1 of the electric field of the electromagnetic wave 6 emitted by the radar sensor 4.

What is claimed is:

1. A vehicle part intended to be placed facing an emission cone of a radar sensor of the vehicle, the radar sensor being configured to emit an electromagnetic wave in the emission cone, the electric field of the electromagnetic wave emitted by the radar sensor includes a component oscillating in a direction of interest, the electromagnetic wave propagating in a main propagation direction, the part having on one of its faces a system for deicing the part;
with the deicing system including a set of elongate heating elements, at least one subset of the set of elongate heating elements being located in the emission cone of the radar sensor when the part is placed facing the radar sensor and being configured such that each elongate heating element of the subset is arranged on the part in such a way as to extend in a direction substantially perpendicular to the direction of interest of the electric field of the electromagnetic wave emitted by the radar sensor when the part is placed facing the radar sensor.

2. The vehicle part as claimed in claim 1, wherein the elongate heating elements extend in the same plane, the plane extending perpendicular to the main propagation direction of the electromagnetic wave emitted by the radar sensor.

3. The vehicle part as claimed in claim 2, wherein the elongate heating elements extend parallel to one another in the plane, the set of elongate heating elements forming a grid wave polarizer.

4. The vehicle part as claimed in claim 3, wherein the elongate heating elements are arranged such that the distance separating two adjacent elongate heating elements is constant.

5. The vehicle part as claimed in claim 4, wherein the distance separating two adjacent elongate heating elements is less than the wavelength of the electromagnetic wave emitted by the radar sensor.

6. The vehicle part as claimed in claim 4, wherein the distance separating two adjacent elongate heating elements is less than 5 mm.

7. The vehicle part as claimed in claim 6, wherein the ratio between the width of each elongate heating element and the wavelength of the electromagnetic wave emitted by the radar sensor is less than 1/10.

8. The vehicle part as claimed in claim 7, wherein the width of each elongate heating element is less than 0.5 mm.

9. The vehicle part as claimed in claim 2, wherein a first subset of elongate heating elements is located in the emission cone of the radar sensor when the part is placed facing the radar sensor, and a second subset of elongate heating elements is located outside the emission cone of the radar sensor when the part is placed facing the radar sensor, the elongate heating elements of the first and second subsets being arranged such that, considering a direction of travel from the second subset to the first subset perpendicular to the main propagation direction of the electromagnetic wave emitted by the radar sensor, and from the outside of the emission cone of the radar sensor to the center of the emission cone, the distance separating two adjacent elongate heating elements is non-constant and follows an increasing distance profile function.

10. The vehicle part as claimed in claim 9, wherein the increasing distance profile function is a linear function, or a piecewise linear function.

11. The vehicle part as claimed in claim 9, wherein the minimum distance separating two adjacent elongate heating elements of the first subset of elongate heating elements is greater than 2 mm.

12. The vehicle part as claimed in claim 9, wherein the width of each elongate heating element of the first subset of elongate heating elements is less than 0.5 mm.

13. The vehicle part as claimed in claim 1, wherein the elongate heating elements are heating metal strips or wires.

14. The vehicle part as claimed in claim 13, wherein each heating metal strip or wire is coated with a layer of a dielectric material or is arranged in a dielectric protection and insulation element.

15. The vehicle part as claimed in claim 14, wherein the dielectric material has a refractive index and a thickness which is between 0.8 times and 1.2 times an ideal thickness, the ideal thickness being equal to a natural number multiplied by the wavelength of the electromagnetic wave emitted by the radar sensor and divided by twice the refractive index of the dielectric material, for a zero angle of incidence of the electromagnetic wave.

16. The vehicle part as claimed in claim 1, wherein the vehicle part is a style part intended to conceal the radar sensor.

17. The vehicle part as claimed in claim 16, wherein the style part is a logo.

18. The vehicle part as claimed in claim 1, wherein the vehicle part is an outer lens that closes off a lighting and/or signalling element in which the radar sensor is integrated.

19. An assembly comprising a vehicle radar sensor and a vehicle part, wherein the radar sensor is configured to emit an electromagnetic wave in an emission cone, the electric field of the electromagnetic wave emitted by the radar sensor including a component oscillating in a direction of interest, the electromagnetic wave propagating in a main propagation direction, the vehicle part being placed facing the emission cone of the radar sensor, with the vehicle part having on one of its faces a system for deicing the part, with the deicing system including a set of elongate heating elements, at least one subset of the set of elongate heating elements being located in the emission cone of the radar sensor when the part is placed facing the radar sensor and being configured such that each elongate heating element of the subset is arranged on the part in such a way as to extend in a direction substantially perpendicular to the direction of interest of the electric field of the electromagnetic wave emitted by the radar sensor when the part is placed facing the radar sensor.

20. The assembly as claimed in claim 19, wherein the radar sensor is a millimeter radar sensor polarized in a horizontal or vertical polarization direction.

21.-23. (canceled)
